(19) United States
(12) Patent Application Publication
(10) Pub. No.: US 2016/0033067 A1
(43) Pub. Date: Feb. 4, 2016

(54) MAGNETIC VACUUM HOSE COUPLER

(71) Applicant: Scott S. STUTZMAN, Indiana, PA (US)

(72) Inventor: Scott S. STUTZMAN, Indiana, PA (US)

(21) Appl. No.: 14/447,777

(22) Filed: Jul. 31, 2014

(51) Int. Cl. F16L 37/00; F16L 21/08

(52) U.S. Cl. CPC F16L 37/004; F16L 21/08

(57) ABSTRACT

A magnetic vacuum hose coupler. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### BACKGROUND

1. Technical Field

The present application relates to a magnetic vacuum hose coupler.

2. Background Information

Background information is for informational purposes only and does not necessarily admit that subsequently mentioned information and publications are prior art.

The current method for connecting vacuum hoses (mainly large hoses between 20″ and 24″) to equipment and to each other is duct tape, ratchet straps, or a snap lever connecting band. Duct tape does not work well in wet environments. Ratchet straps take time and it is awkward to hold the hose in place while placing and tightening the ratchet strap.

### OBJECT OR OBJECTS

An object of the present application is to reduce the stress and demand of connecting a vacuum hose to a vacuum unit.

### SUMMARY

This application describes an embodiment which makes it much easier to connect vacuum hoses to the vacuum unit, to manifolds, and to each other. One embodiment of the application uses high power magnets (rare earth, primarily Neodymium) to attach to vacuum sources and end-use equipment and for attaching hoses together. This application describes an embodiment which makes connecting hoses less stressful and demanding because it is quick and works in any weather. This magnetic coupler is versatile, quick, and efficient. It can be manufactured out of essentially any material that is sufficiently strong enough to maintain its shape.

The above-discussed embodiments of the present invention will be described further herein below. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

FIG. 1 shows a side view of a magnetic vacuum hose coupler according to at least one possible embodiment of the present application;

FIG. 2 shows a front view of the magnetic vacuum hose coupler;

FIG. 3 shows a possible connection of two vacuum hoses by magnetic couplers using a male end to a male end;

FIG. 4 shows a view of the female end and its female flange;

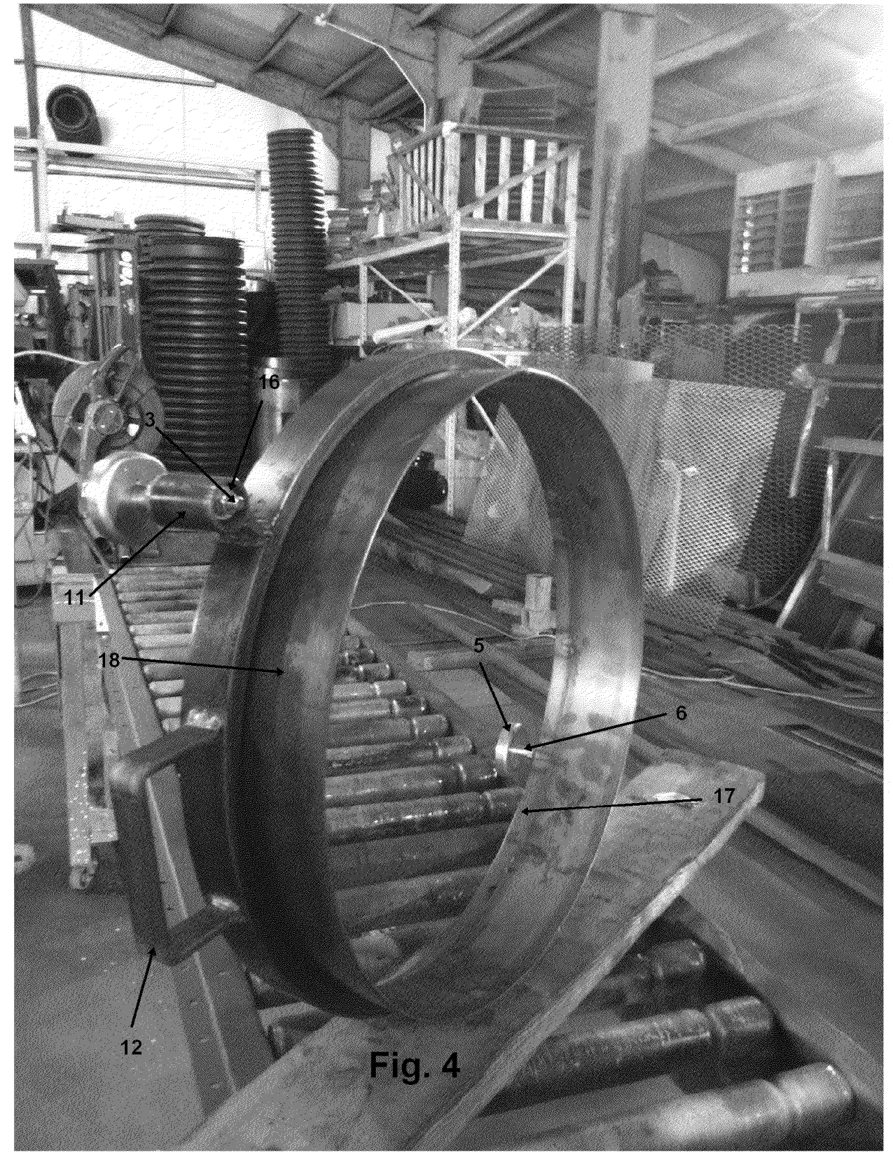

FIG. 5 shows a side view of the female end, its female flange and gasket;

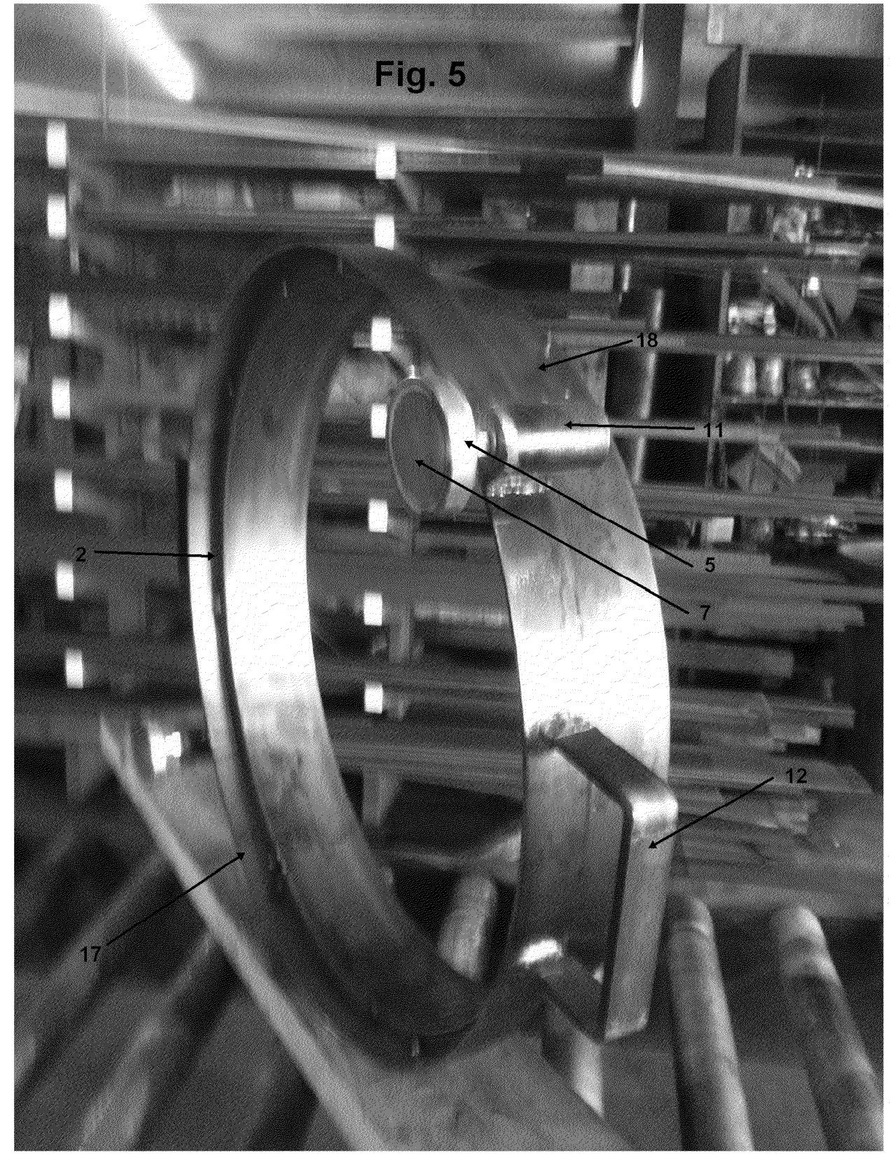

FIG. 6 shows a front view of the female end and its gasket;

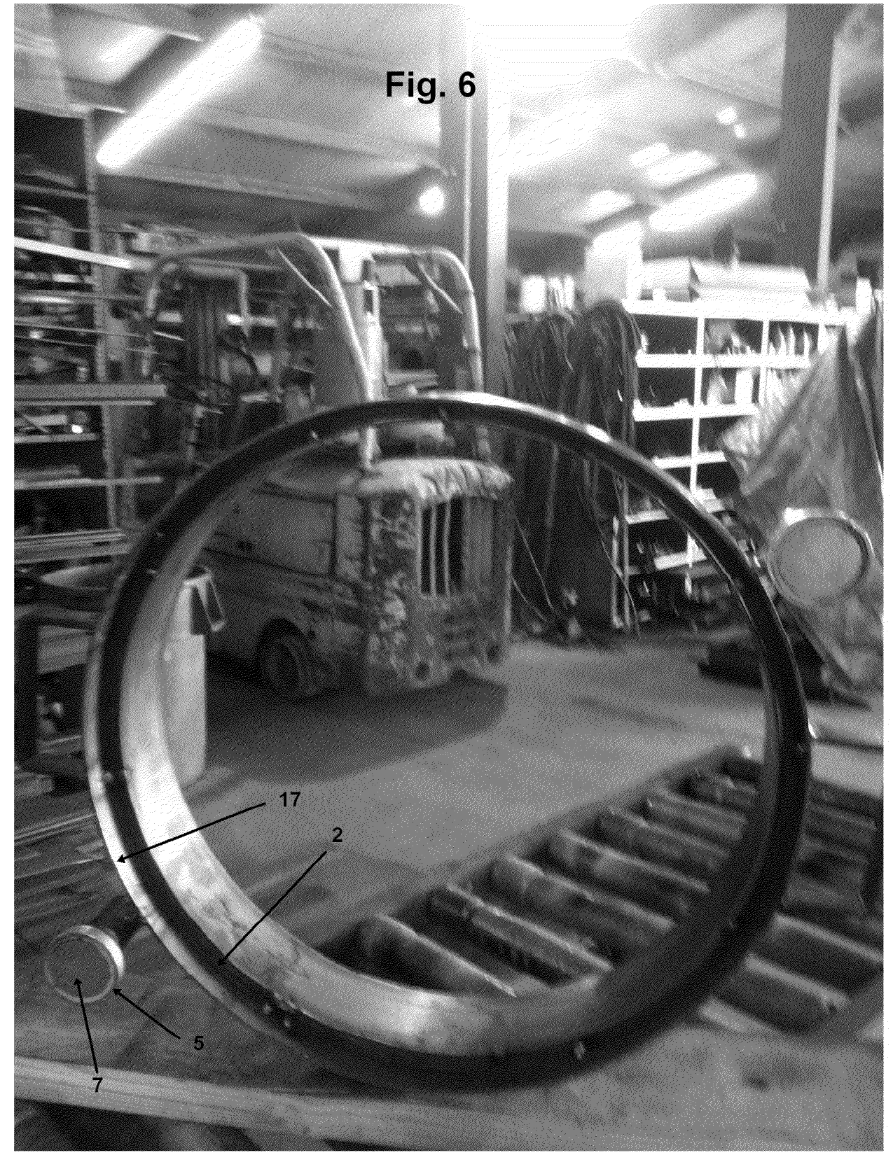

FIG. 7 shows a possible embodiment of a connector box that can be attached to the top of a proppant storage trailer; AND

FIG. 8 shows a possible embodiment of a proppant storage trailer.

### DESCRIPTION OF EMBODIMENT OR EMBODIMENTS

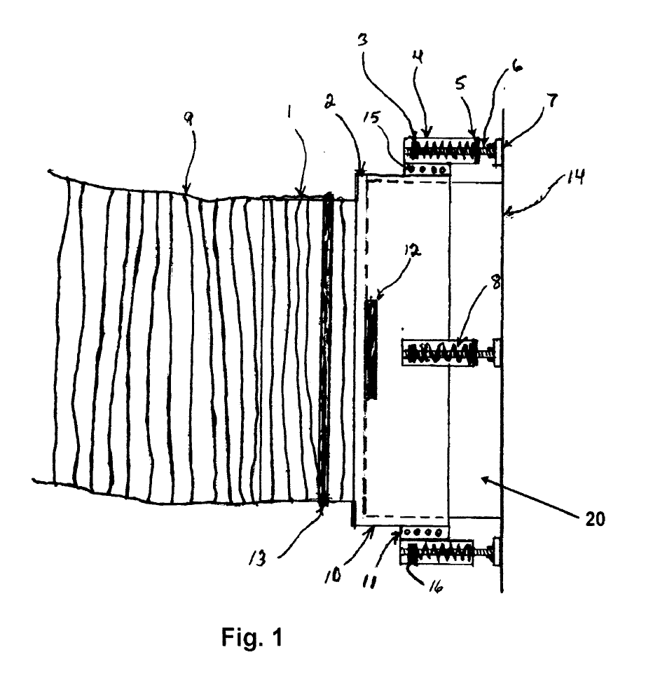

The application describes an embodiment in which a coupler 21 is fabricated to a desired diameter. As shown in FIG. 1, it is fabricated with a male end 1 and a female end 10. The male end 1 of the coupler 21 is ring shaped with an indented flange 18 on the outer portion of the ring. The female end 10 of the coupler is ring shaped with an indented flange 17 on the inside of the ring. These flanges 17,18 allow for the large flex vacuum hose 9, as well as a sealing gasket 2, to be fitted easily around the male end 1. The bonding agent 13 to hold said hose to the coupler 21 can consist of an adhesive or a circular band.

The application describes an embodiment which is fabricated with a desired number of spring and alignment retainers 4 and a corresponding amount of magnets 7. In one possible embodiment there could be four or more magnets, or three or less magnets, as long as the number of magnets 7 is equal to the number of load bearing surfaces 5, the number of bolts 6, the number of tension springs 8, the number of tension nuts 3, and the number of washers under the tension nuts 16. The magnets 7 and the tension springs 8 determine the load/weight that the coupler 21 can maintain. The springs 4 allow for coupling to uneven steel surfaces. The magnets 7 are rare earth (Neodymium 165 lbs load, 660 lbs combined force using 4 magnets) that supply the force to hold the coupler 21 to the desired item to be coupled to. There is also a tension nut 3 at the end of each spring 8. The vacuum flex hose 9 is attached to the male end 1 of the coupler 21 and held on by a broad clamp or bonding agent 13. The hose/coupler can now be slid over the corresponding mating flange 20 and the magnets 7 self-engage as soon as they are close the mating surface 14. There is a handle 12 attached to the side of each coupler 21 for easier movement.

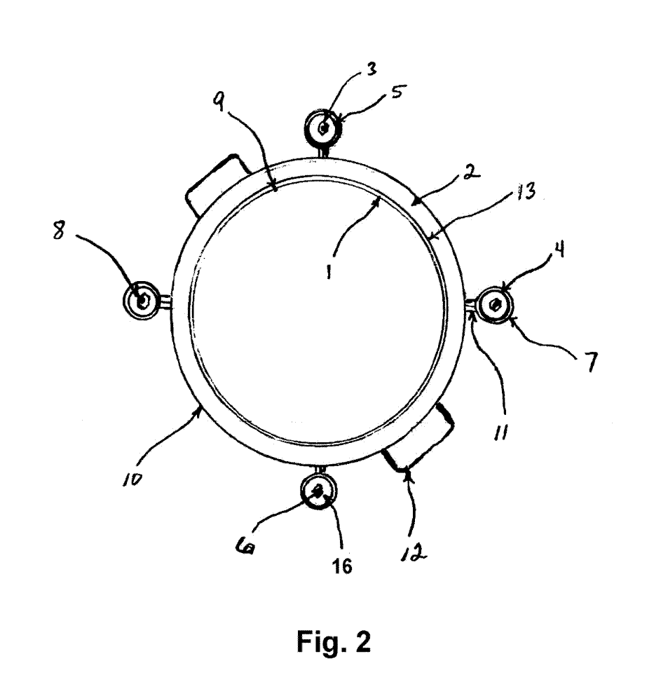

The male end 1 is designed to allow a large flex vacuum hose 9 to encircle the male portion of the coupler, as shown in FIG. 2. The coupler 21 itself is secured to the mounting surface 14 (which in one particular embodiment of the invention could be a mountain mover) by means of rare earth magnets 7. Each magnet 7 is connected to a bolt 6, which runs upward from the magnet 7, into a spring and alignment retainer 4. Inside said spring and alignment retainer 4, a tension spring 8 surrounds the bolt 6. Said tension springs 8 allow for the rare earth magnets 7 to attach to differently shaped surfaces where bolts of differing lengths would be necessary for the magnets 7 to reach said surface.

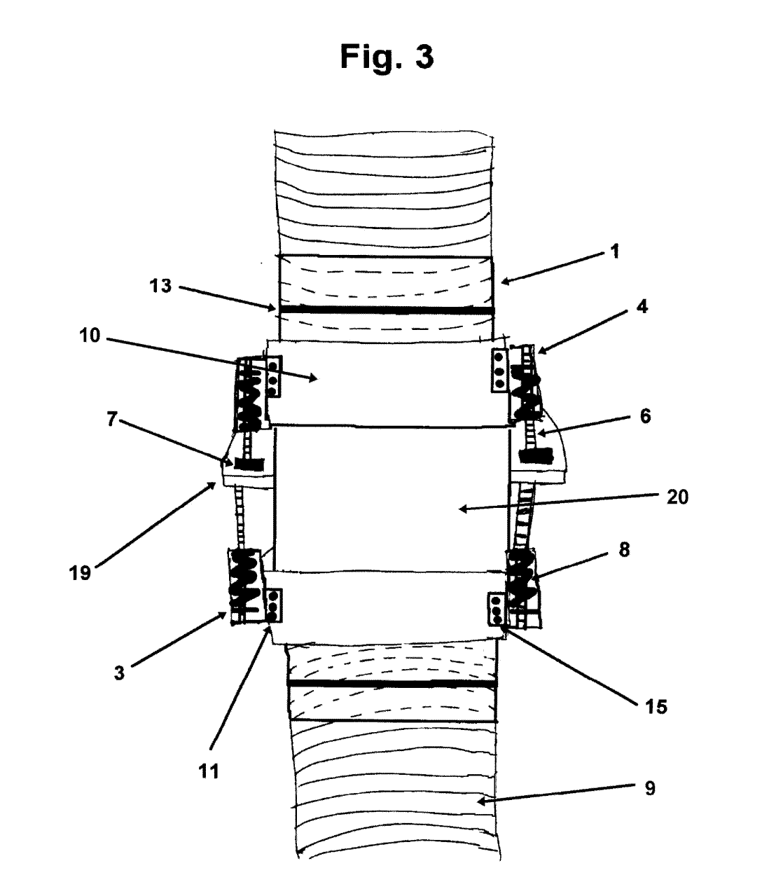

Referring to FIG. 3, the coupler 21 can also be used to connect a coupler's hose-covered male end 1 to another hose-covered male end 1 through the female ends 10 of both couplers, and with the assistance of a large washer 19. The two couplers 21 can be placed against one another, having the large washer 19 go between the magnets 7, but not between the female end 10 connecting parts. A large tube-shaped mating flange 20 can be placed between the two couplers 21, acting as an intermediate male end 1 for both connecting female ends 10. The rare earth magnets 7 are attached to the sides of the male ends 1 by a spacer for spring alignment 11 (which are attached through the bolt adjustment holes 15) connected to the spring alignment retainer 4. Inside the alignment retainer 4 are the tension springs 8 and the bolts 6 with the magnets 7 on the end which allow the coupler to align to any even or uneven surface. The magnets 7 will be used to grip to the washer 19 in between the male ends 1.

These couplers can also be used to in among other applications connect to hydraulic fracturing devices. In hydraulic fracturing, a proppant is used to keep the fractures open, which proppant is often a silica-containing material, such as silica sand and resin-coated silica sand. Many tons of proppant are used at a hydraulic fracturing site, thereby exposing workers to inhalation of silica dust, which can lead to a lung disease known as silicosis, or Potter's rot. The connectors of a coupling embodiment can be used to safely transport silica dust away from the hydraulic fracturing site.

When preparing proppant for use in hydraulic fracturing, large amounts of dust, such as silica dust and other proppant dust, are created by the movement of proppants. This dust can produce potential detrimental effects, such as contaminating atmospheric air, creating a nuisance to adjacent landowners, and damaging equipment on the hydraulic fracturing site. A significant concern, as discussed above, is the inhalation of silica dust or other proppant dust, which can lead to lung conditions such as silicosis and other specific forms of pneumoconiosis.

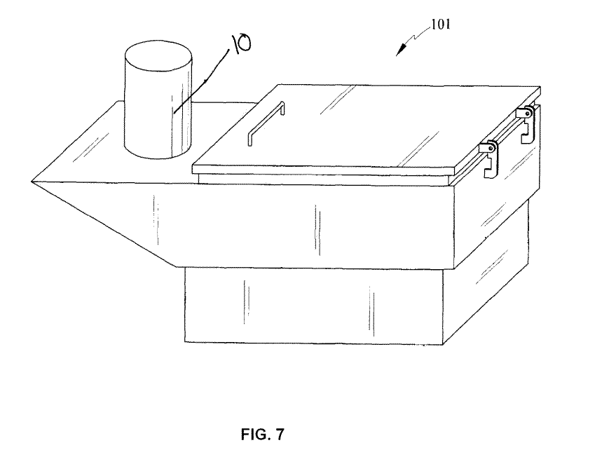

The flex vacuum hose 9 can be connected to proppant storage trailers, which are used to safely contain the silica dust. The magnetic vacuum couplers can attach to most surfaces equipped to be used in the process of moving dust. This allows for a longer extension of tubing for the silica dust to travel through. A possible embodiment of a connector box shown in FIG. 7 allows for the flex vacuum hose 9 to attach to its surface. The hose 9 will attach at the male ring 1 and the rare earth magnets 7 will secure the connection against the surface 14 of a connector box 101. The male ring 1 will fit snugly inside of the circular openings of the connector box 101. One embodiment of the coupler has a 24″ female end, which corresponds with the 24″ opening (which is a standard size for some of these openings) in connecter boxes 101.

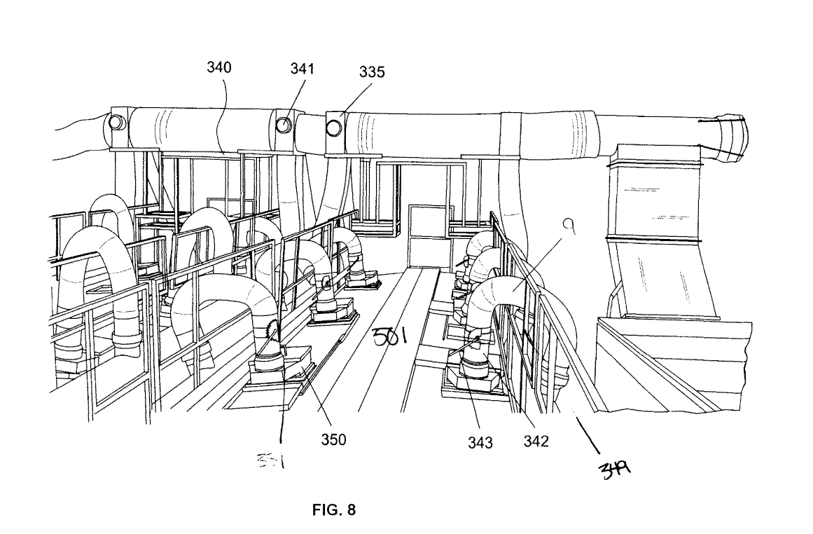

In another possible embodiment of a connector box 101, shown in FIG. 8, three tubes can be attached to a single connector box. One hose can be attached to be used with the middle opening for the box. The other two openings can be used for hoses originating at individual hydraulic fracturing sites. This allows for many different mountain movers to remove the silica dust at one time. This box, called the T-box 300, creates an easy way to remove dust from two separate hydraulic fracturing sites and have all of said dust end up contained in a single proppant storage trailer. The rare earth magnets allow for a connection to most any surface feasible.

As shown in FIG. 9, the flex vacuum hose can be connected to the mountain movers through the tops of said mountain movers. The vacuum hoses 9 will be routed through bars 349 that enclose the upper platform of said mountain movers and attach to the top surface 501 at points 350. These points will be openings in the surface 501 of the platform that allow for said hoses 9 to couple to them. The rare earth magnets 7 will attach to the surfaces 351, which are located on top of the connector surface 500.

As shown in FIG. 10, the surfaces 350 are shaped with a lower box-shaped portion 352 and an upper trapeziodally box-shaped area 350.

The lower box-shaped area 352 will be placed inside of the upper surface of the mountain movers, allowing for secure placement of the connecting surfaces 500.

One feature or aspect of an embodiment is believed at the time of the filing of this patent application to possibly reside broadly in a magnetic hose coupler being configured to connect large flexible hoses having diameters in the order of about one foot or greater, said coupler comprising: a body comprising: a male portion configured to be connected to a large flexible hose; a female portion opposite said mail portion being configured to be connected to a rigid sleeve; magnets disposed about the periphery of said female portion being configured to magnetically attach to a ferromagnetic member; each said magnet comprising an adjusting arrangement configured to extend said magnet and adjust said magnet to couple and hold with said magnet said coupler to a ferromagnetic member; and each said magnet comprising a biasing member configured to adjust said magnet which biasing member is connected to associate with each said adjusting arrangement.

The components disclosed in the patents, patent applications, patent publications, and other documents disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications, patent publications, and other documents cited herein, and in the Declaration attached hereto, are hereby incorporated by reference as if set forth in their entirety herein except for the exceptions indicated herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, patent applications, patent publications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, patent applications, patent publications, and other documents either incorporated by reference or not incorporated by reference.

U.S. patent application 61/451,435, filed on Mar. 10, 2011, having inventor(s) Scott S. STUTZMAN, Attorney Docket No. NHL-FRA-01-PROV, and title METHOD AND APPARATUS FOR COLLECTING DUST, SAND DUST, AND/OR SAND DURING HYDRAULIC FRACTURING OF MARCELLUS SHALE is hereby incorporated by reference as if set forth in their entirety herein.

U.S. patent application 61/590,233, filed on Jan. 24, 2012, having inventor(s) Scott S. STUTZMAN, Attorney Docket No. NHL-FRA-02-PROV, and title METHOD FOR PREPARING PROPPANT, SUCH AS SILICA SAND, RESIN-COATED SILICA SAND, AND CERAMIC PROPPANT MATERIALS, AND APPARATUS THEREFOR is hereby incorporated by reference as if set forth in their entirety herein.

U.S. patent application Ser. No. 13/416,256, filed on Mar. 9, 2012, having inventor(s) Scott S. STUTZMAN, Attorney Docket No. NHL-FRA-04 US, and title METHOD OF REDUCING SILICOSIS CAUSED BY INHALATION OF SILICA-CONTAINING PROPPANT, SUCH AS SILICA SAND AND RESIN-COATED SAND, AND APPARATUS THEREFOR is hereby incorporated by reference as if set forth in their entirety herein.

U.S. patent application Ser. No. 13/606,913, filed on Sep. 7, 2012, having inventor(s) Scott S. STUTZMAN, Attorney Docket No. NHL-FRA-04-CIP, and title METHOD OF REDUCING SILICOSIS CAUSED BY INHALATION OF SILICA-CONTAINING PROPPANT, SUCH AS SILICA SAND AND RESIN-COATED SAND, AND APPARATUS THEREFOR is hereby incorporated by reference as if set forth in their entirety herein.

U.S. patent application Ser. No. 13/836,108, filed on Mar. 15, 2103, having inventor(s) Scott S. STUTZMAN, Attorney Docket No. NHL-FRA-05-PRI, and title METHOD OF REDUCING SILICOSIS CAUSED BY INHALATION OF SILICA-CONTAINING PROPPANT, SUCH AS SILICA SAND AND RESIN-COATED SAND, AND APPARATUS THEREFOR is hereby incorporated by reference as if set forth in their entirety herein.

U.S. patent application 61/786,274, filed on Mar. 14, 2013, having inventor(s) Scott S. STUTZMAN, Attorney Docket No. NHL-FRA-06-PROV, and title METHOD OF REDUCING SILICOSIS CAUSED BY INHALATION OF SILICA-CONTAINING PROPPANT, SUCH AS SILICA SAND AND RESIN-COATED SILICA SAND, AND APPARATUS THEREFOR is hereby incorporated by reference as if set forth in their entirety herein.

U.S. provisional patent application 61/858,989, filed on Jul. 26, 2013, having inventor(s) Scott S. STUTZMAN, Attorney Docket No. NHL-FRA-07-PROV, and title MAGNETIC VACUUM HOSE COUPLER is hereby incorporated by reference as if set forth in their entirety herein.

U.S. provisional patent application 61/860,605, filed on Jul. 31, 2013, having inventor(s) Scott S. STUTZMAN, Attorney Docket No. NHL-FRA-07-PROV, and title MAGNETIC VACUUM HOSE COUPLER is hereby incorporated by reference as if set forth in their entirety herein.

All of the references and documents cited in any of the patents, patent applications, patent publications, and other documents cited herein, except for the exceptions indicated herein, are hereby incorporated by reference as if set forth in their entirety herein except for the exceptions indicated herein. All of the patents, patent applications, patent publications, and other documents cited herein, referred to in the immediately preceding sentence, include all of the patents, patent applications, patent publications, and other documents cited anywhere in the present application.

Words relating to the opinions and judgments of the author of all patents, patent applications, patent publications, and other documents cited herein and not directly relating to the technical details of the description of the embodiments therein are not incorporated by reference.

The words all, always, absolutely, consistently, preferably, guarantee, particularly, constantly, ensure, necessarily, immediately, endlessly, avoid, exactly, continually, expediently, ideal, need, must, only, perpetual, precise, perfect, require, requisite, simultaneous, total, unavoidable, and unnecessary, or words substantially equivalent to the above-mentioned words in this sentence, when not used to describe technical features of one or more embodiments of the patents, patent applications, patent publications, and other documents, are not considered to be incorporated by reference herein for any of the patents, patent applications, patent publications, and other documents cited herein.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The details in the patents, patent applications, patent publications, and other documents cited herein may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

### AT LEAST PARTIAL LIST OF NOMENCLATURE

1. male vacuum hose connector
2. sealing gasket
3. tension nut
4. spring and alignment retainer
5. load bearing surface
6. bolt on all thread
7. rare earth magnets
8. tension spring
9. large flex vacuum hose
10. female connection ring
11. spacer for spring alignment retainer
12. handle
13. bonding to hold hose to coupler
14. surface to be coupled to
15. bolt adjustment holes
16. washer under nut
17. female flange
18. male flange
19. large washer
20. mating flange
21. coupler

What is claimed is:

1. A magnetic hose coupler being configured to connect large flexible hoses having diameters in the order of about one foot or greater, said coupler comprising:
a body comprising:
a male portion configured to be connected to a large flexible hose;
a female portion opposite said mail portion being configured to be connected to a rigid sleeve;
magnets disposed about the periphery of said female portion being configured to magnetically attach to a ferromagnetic member;
each said magnet comprising an adjusting arrangement configured to extend said magnet and adjust said magnet to couple and hold with said magnet said coupler to a ferromagnetic member; and
each said magnet comprising a biasing member configured to adjust said magnet which biasing member is connected to associate with each said adjusting arrangement.
